(19) United States
(12) Patent Application Publication
(10) Pub. No.: US 2016/0324136 A1
(43) Pub. Date: Nov. 10, 2016

(54) Horse Shoe

(71) Applicant: VIBRAM S.P.A., Albizzate (Varese) (IT)

(72) Inventors: Aurora Silanus, Abizzate (Varese) (IT); Vincenzo Carpentieri, Abizzate (Varese) (IT); Silvia Bramani, Abizzate (Varese) (IT)

(21) Appl. No.: 15/109,262

(22) PCT Filed: Jun. 19, 2014
(86) PCT No.: PCT/IB2014/062433

§ 371 Date: Jun. 30, 2016

(30) Foreign Application Priority Data
Jun. 20, 2013 (IT) VR2013A000148

(51) Int. Cl. A01L 5/00; A01L 7/02; A01K 13/00

(52) U.S. Cl. CPC A01L 5/00; A01K 13/007; A01L 7/02

(57) ABSTRACT

Horse shoe, having a frusto-conical shape, that reproduces the shape of the horse foot, made of elastic material, the shoe can be associated to at least the hoof of the animal, without locking means, via an elastically deformable coupling, so as to ensure the easy insertion and adaptation of the shoe to any foot and allowing the optimal protection of the foot and the natural gait of the horse.

### TECHNICAL FIELD OF THE INVENTION

The present invention relates to a horse boot.

In particular, the present invention relates to a horse shoe which is simple and quick to use that allows the natural walking of horses, ensuring optimal protection of the hoof and preventing the possible onset of pain related to stimuli coming from the ground.

Moreover, the present invention relates to a horse shoe to be used for orthopedic purposes or during the treatment or convalescence of the horse.

In fact, the footwear according to the present invention ensures an easy insertion and adaptation on the horse's foot and allows optimal protection of the foot both under normal conditions and during a period of convalescence or treatment of the horse as well as the natural walking of the horse in normal conditions.

### DESCRIPTION OF RELATED ART

In the horse field, different known types of horse boots have long been widespread, normally used to protect from any possible injury and to reduce the plantar sensitivity of horses that still have a reduced thickness of nail due to the recent removal of the horseshoes or of horses that have long been barefoot, but subjected to long and continuous paths on hard or rocky and uneven soils.

Known boots generally comprise a sole, associated to an above upper, and removable locking means for the closure of the boot itself on the hoof and possibly also on other parts of the horse digit.

Known boots are made of different materials, such as synthetic fabrics, leather, rubber, plastic, and still other materials.

The above locking means can be of various types: in some cases they consist of bands with Velcro type closures located for example at the pastern; in other cases they consist of closures of the ratchet type that clamp the boot at the walls or the heels of the hoof.

In further embodiments, the locking means consist of plastic shells which can be tightened on the bulbs of the horse digit through belts that can be tightened; in still other embodiments, various kinds of laces, adjustable straps also metallic, and hybrid solutions of the foregoing can be provided, which allow closing the boot.

However, the horse boots of the known type have drawbacks due to the fact that the used locking means force the operator to pay particular attention to perform the closure of the boot, since they need long and laborious adjustments to be made. For certain types of boots, the closing operations also require the use of suitable tools, increasing, in addition to the time necessary for the fitting and fastening thereof, the volume and weight of the equipment to be carried in possible walks, if the user wants to carry such boots during horse rides.

Moreover, in many cases the location of the locking means and, in general, the shape of the boots are such as to make them complicated to wear on the horse foot. Moreover, the locking means and/or the materials used do not always ensure a suitable fastening on all the various types of hoof; therefore, some known boots cannot adapt to the different shapes of horse foot.

Moreover, there are boots made of elastic material that require resin or glue to be attached to the hoof. This fastening mode, in addition to making such boots not removable until the final extraction, limits the natural transpiration of the horse foot.

Again, the above mentioned locking means involve additional working steps during the production of the boots, impacting negatively on the production timing and costs.

Finally, some types of known boots have soles, made of excessively rigid materials, which do not allow the proper sensitivity to the animal during resting on the ground, altering the physiological walking thereof.

### SUMMARY OF INVENTION

The technical task of the present invention therefore is to develop a horse shoe which can simply be worn on the foot of the animal without the use of locking means of the known type.

Within this technical task, a particular object of the present invention is to provide a horse shoe that ensures excellent protection to the foot of the animal, which does not require special locking means while allowing optimum fastening to the feet themselves, in their different conformations and which is light, not bulky, easy to carry.

A further object of the present invention is to provide a shoe that reduces the sensitivity of the animal to plantar pressures from hard or rocky or disconnected soils while ensuring a natural walking.

A further object of the present invention is to provide a shoe usable in orthopedics as an aid during the treatment and/or convalescence of the horse.

This task and this object are achieved by the horse shoe according to the present principles.

The horse shoe comprises a main body which has a frusto-conical shape, which reproduces the natural shape of the horse foot and which is made of an elastic material; this main body is associable to at least the hoof of the animal via an elastically deformable coupling, so as to ensure the easy insertion and adaptation of the shoe on the foot, allowing the optimum protection of the foot from excessive plantar pressures and, at the same time, the natural walking of the horse.

Further advantageous features are described in the present specification.

### BRIEF DESCRIPTION OF THE DRAWINGS

The features of the invention shall be better understood by any man skilled in the art from the following description and annexed drawing tables, provided by way of a non-limiting example, wherein:

FIG. 1 shows a side view of a horse shoe according to the present invention;

FIG. 2 shows a back view of a horse shoe according to the present invention;

FIG. 3 shows a bottom view of a horse shoe according to the present invention;

FIG. 4 shows a side view of a horse shoe according to a first variant of the present invention;

FIG. 5 shows a side view of a horse shoe according to a second variant of the present invention;

FIG. 6 shows a side view of a horse shoe according to a third variant of the present invention;

FIG. 7 shows a bottom view of a horse shoe of FIG. 6;

FIG. 8 shows a top view of a horse shoe of FIG. 6;

FIG. 9 shows a side view of a horse shoe according to a fourth variant of the present invention;

FIG. 10 shows a bottom view of a horse shoe of FIG. 8;

FIG. 11 shows a back view of a horse shoe of FIG. 8; and

FIG. 12 shows a side view of a further version of the horse shoe according to the present invention.

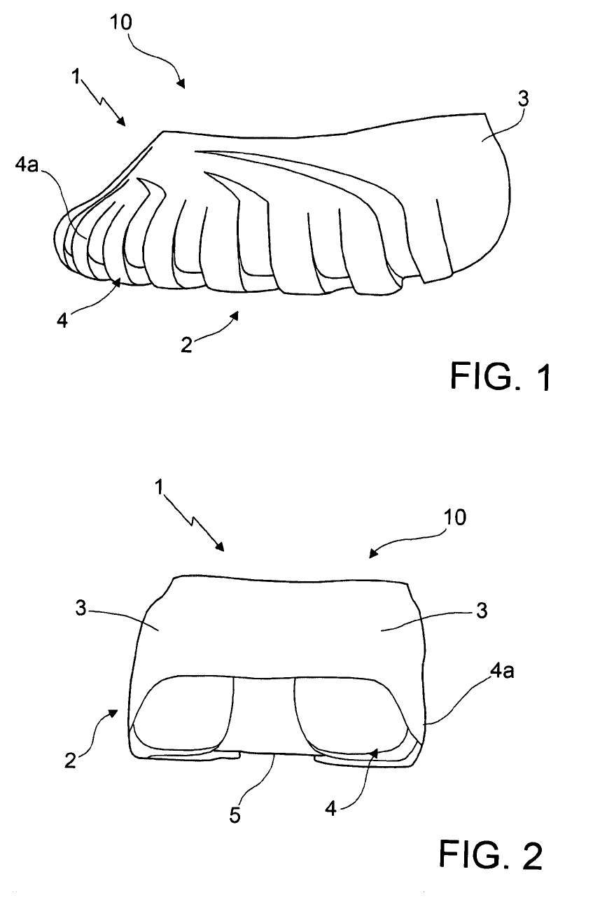

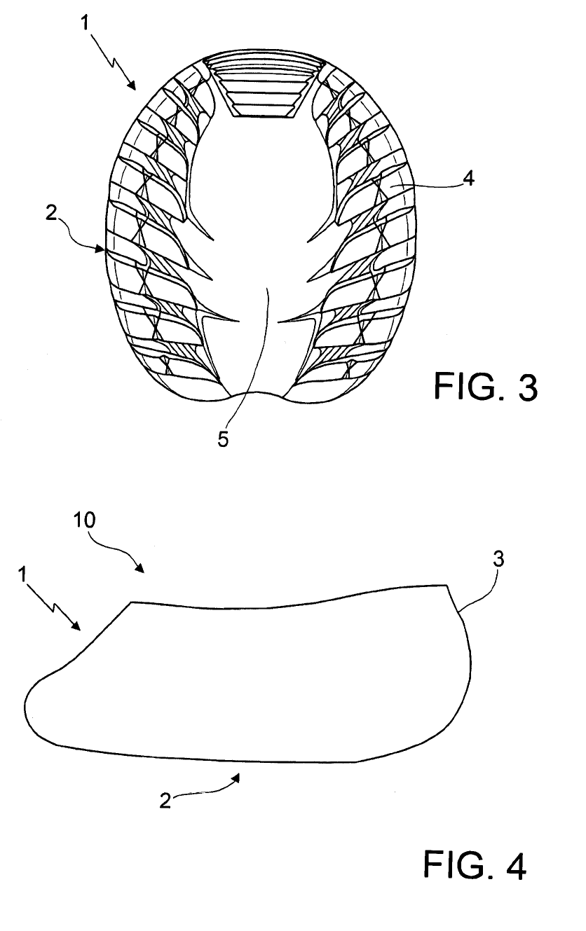

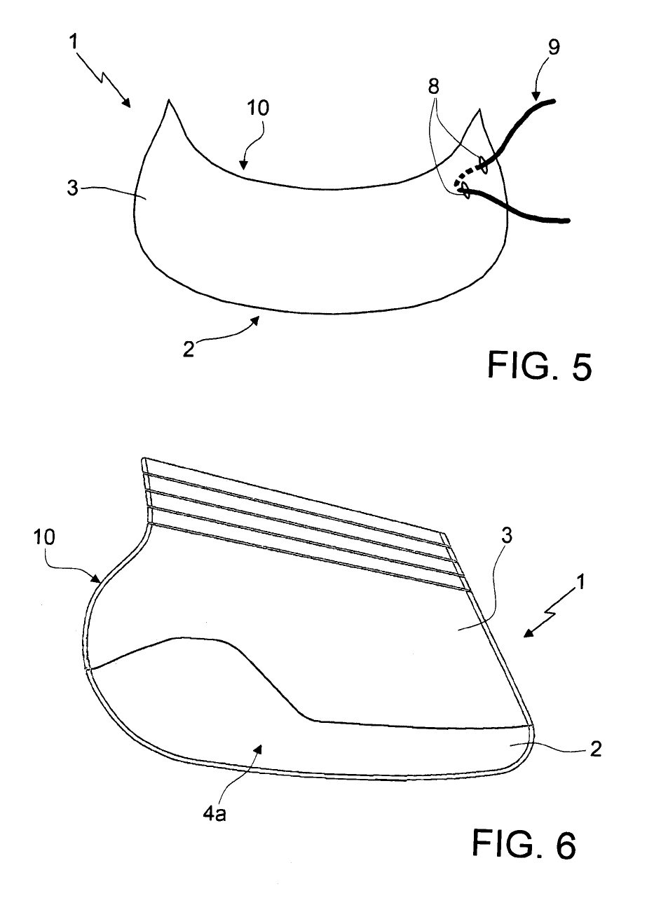

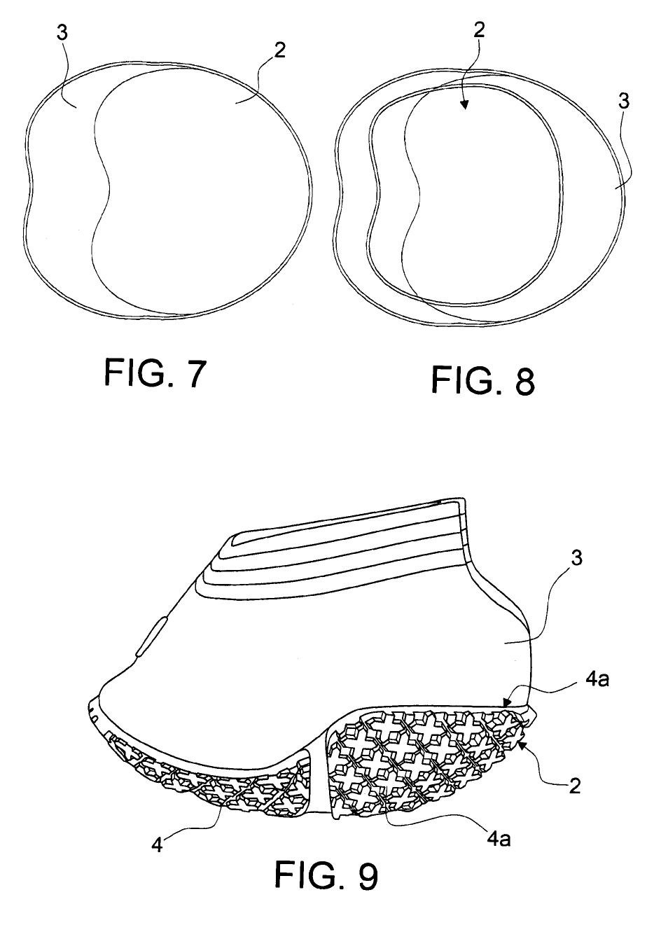

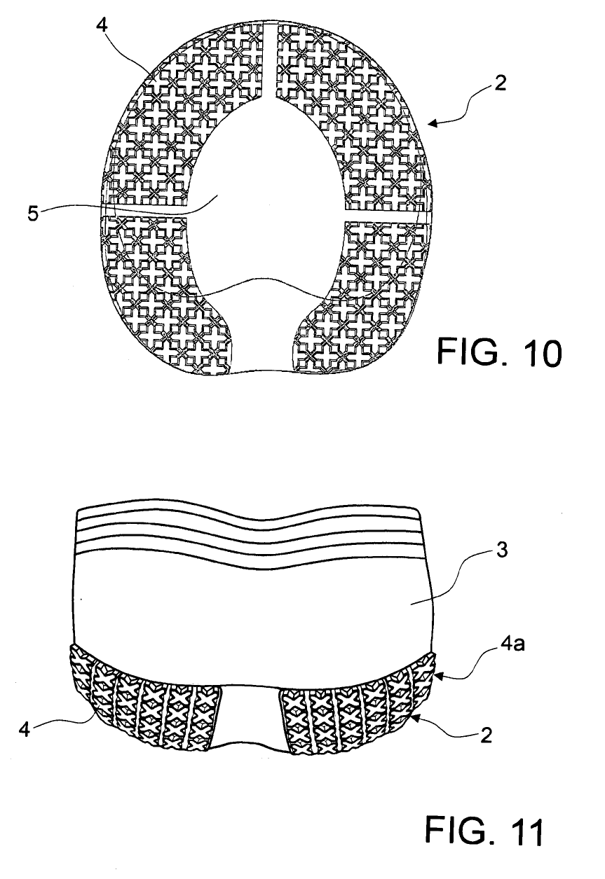

### DETAILED DESCRIPTION OF THE INVENTION

With reference to the annexed drawings, reference numeral 1 globally denotes a horse shoe according to the present invention.

For example, such a boot is adapted to be fitted barefoot or on unshoed feet during walks or field work. According to a further example, such a footwear can be fitted on bare feet in stabling for a treatment or convalescence of the horse.

The horse shoe comprises a main body 10 which has a frusto-conical shape, which reproduces the natural shape of the horse foot. The main body 10 is made of elastic material, i.e. extensible, meaning that it can change from a so-called rest size to a so-called enlarged size, following the application of an extension force.

Specifically, shoe 1, through manual extension of the walls of the main body 10, reaches an enlarged size, adapted to allow the insertion of the horse foot and, upon release of the tension applied manually on the walls of the main body 10, the elastic material, that makes up such a shoe 1 and/or such a main body 10, is released and adheres adapting to the size and shape of the horse foot inserted into the same.

The main body 10 comprises a sole portion 2 and a fitting portion 3, associable to at least the animal's hoof via an elastically deformable coupling, so as to ensure the easy insertion and adaptation of shoe 1 on the foot, allowing the optimal protection of the foot itself, a reduction of sensitivity to stresses from the ground and, at the same time, the natural gait of the horse.

The sole portion 2 acts as a portion of the sole of shoe 1. The fitting portion 3 is placed on top of the sole portion 2, considering the horse foot resting on the ground.

In one version of the invention, the sole portion 2 may comprise a tread 4. By tread 4 it is meant that part basically resting on the ground of the sole portion 2, adapted to increase the grip on and lessen the stresses from the ground. Tread 4 may comprise an engraving.

In a first variant of the invention and in a third variant, tread 4 is not present.

Such a tread 4, when present, may be made of a material with a different degree of elasticity than that of the main body 10.

For example, tread 4 may be made of a material harder than that of the main body 10, so as to absorb the shocks, withstand the pressure of the horse's weight and reduce the wear of the same.

Tread 4 follows at least inferiorly the hoof shape.

In a particular version of the invention, tread 4 is open at the back. Tread 4 may follow the shape of the hoof substantially from the tip of the same, up to the heels and bars.

The sole portion 2 may comprise, in a further version of the invention, a central portion 5 adapted to allow the natural movement of enlargement and reduction (elaterium) of the hoof frog during the walk. The central portion 5 may be elastic, made of the same material as the main body 10 or of a different material or of a different compound than the main body 10 itself or an elastic fabric, possibly of an anti-perforation fabric, etc.

In a particular version, the central portion 5 comprises a central zone of the sole portion 2, identified within tread 4, which extends rearwardly at the opening of tread 4 itself. The central portion 5 is located substantially at the frog of the foot.

In a still further embodiment, tread 4 may have a shape substantially corresponding to that of the sole portion 2.

Tread 4 may also comprise an edge 4a which extends on the fitting portion 3 laterally along the entire circumference of the hoof (on the outer face of the wall) and on the tip of the hoof itself.

As shown for example in FIG. 6, according to features that can be applied also to the other versions or variants of the invention, edge 4a has a different extension between the in use front part of shoe 1 and the in use rear part of the same.

Tread 4 may also comprise an engraving suitable for a safe grip on the ground.

Said fitting portion 3 defines a zone of adhesion or coupling at least with the wall of the hoof and with the bulbs of the animal's foot.

Shoe 1 may be made directly in a single item, i.e. in a single body, possibly by means of a single molding step. Otherwise, shoe 1 may be made by a plurality of pieces associated with each other, for example by gluing, vulcanization, or the like.

In particular, shoe 1 may be made of a material such as rubber, or vulcanized rubber such as, by way of example: butadiene-based rubber (such as polybutadiene or BR), isoprene-based synthetic or natural rubber (IR, NR), IIR or Isobutylene Isoprene Butyl, styrene-butadiene-based rubber (SBR), nitrile rubber, nitrile-butadiene-based rubber (NBR), chloroprene-based rubber (CR), chlorosulfonated polyethylene-based rubber (CSM), bromo butyl isoprene-based rubber (BIIR), chloro butyl isoprene-based rubber (CUR) thermoplastic rubber of the type TPR, TR, silicone, resin, thermoplastic material, polyurethane (PU), thermoplastic polyurethane (TPU), polyester-based thermoplastic polyurethane (TPU), polyether-based thermoplastic polyurethane (TPU), urethane derivatives, elastic material such as ethylene vinyl acetate (EVA), fabric, non-woven fabric, mixtures of the same, rubber-like materials, etc.

The central body 10, or shoe 1, may comprise portions with differentiated elasticity obtained through the use of material having different compounds. The parts with differentiated elasticity of shoe 1 may otherwise be obtained through the use of variable thicknesses of material. Or again, the differentiated elasticity of the different parts of shoe 1 may be obtained by the use of both different compounds and thicknesses.

Shoe 1 may include, in a version of the invention, portions of different materials.

The operation of horse shoe 1 according to the invention is, according to the above description, entirely intuitive.

Thanks to the differentiated elasticity of the main body 10 of shoe 1, the operator can quickly insert the same on the hoof of the horse manually enlarging in a simple way the opening of the fitting portion 3; after which, shoe 1 itself, always by virtue of its differentiated elasticity, will optimally adapt to the shape of the horse foot.

It is possible to envisage that shoe 1, by virtue of the materials used, its elasticity and the specific use for which it is adopted, adapts to any horse foot or different shoe sizes may be provided so that each size is suitable for a specific range of sizes of the foot itself.

In a further version of the invention, once the main body 10 has been fitted, it is possible, for the farrier or user, to attach to the same, through joining means of known type, a tread 4 or shims or covers for the Coronet band of the foot or other components, capable of customizing shoe 1 according to the actual needs of the horse or to the particular use of the shoe itself.

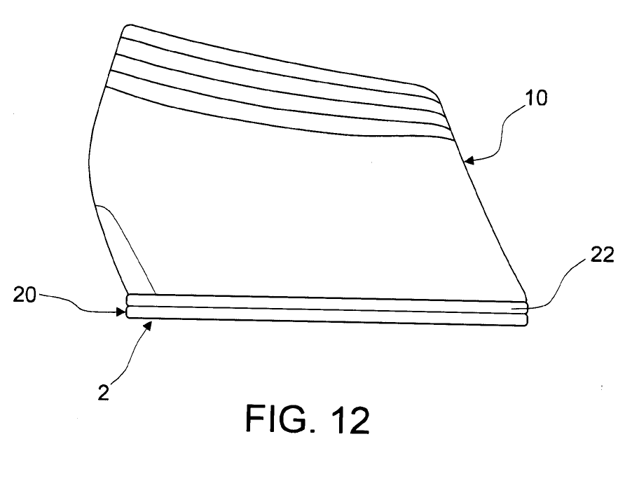

To this end, the present invention refers to a version of the shoe according to the present invention, for orthopedic use as an adjuvant to assist the walking of the horse during the convalescence period, or for other suitable use. Such a version, as shown by way of example in FIG. 12, comprises a main body 10, one or more elements 20 selected from at least one insert or a shim or a tread 4, or a cover for the Coronet band or the wall or the tip of the foot or another component, and coupling means 22 adapted to allow the fastening of such at least one element 20 and shoe 1 itself.

Such at least one element 20 is applicable to the sole portion 2 or to tread 4 of shoe 1.

Such at least one element 20 at least in a variant of the invention is applied on the outer surface of the main body 10 and/or of the sole portion 2, so as to come into at least partial contact with the ground, at the same time without having to contact and affect directly the horse foot. In such a way, such at least one element 20 may be used to improve the walking of the horse, prevent certain areas of the same from being subject to pressures due to the contact with the ground, or still assist the treatment or convalescence of the horse by providing a removable support for the application of medicaments or relieving pressure on specific points of the foot thanks to the shimming of adjacent areas.

Moreover, such at least one element 20 may have a thickness, shape and/or hardness that are variable or variably selectable depending on the farrier's or veterinarian's instructions, based on specific needs.

That is to say, such an element 20 may be selected from a plurality of elements each having a specific thickness and/or a specific shape or conformation and/or a specific hardness in order to meet the specific needs of the user or of the horse.

The coupling means 22 between shoe 1 and such at least one element 20 may include: a glue, Velcro, joint locking means, removable fastening means, adhesive means, magnetized means, etc.

Moreover, such at least one element 20 may have predefined size or may have such a size or extension as to allow the farrier or the veterinarian to cut the element having desired size and shape from a same element, the latter having the same features but being larger in size. In this way, it is also possible to customize shoe 1 according to the specific size and needs of the horse foot, adapting the same in a unique and specific manner.

In this way, the farrier or veterinarian can, considering the specific needs of the horse, select the at least one element 20 needed for the treatment, convalescence or walking of the horse, apply such at least one element 20, through the above-mentioned coupling means 22, to the main body 10 and/or to its sole portion 2, in a specific selected area according to the specific needs of the horse, fit shoe 1 on the horse foot, the shoe being thereby customized for a particular horse and for a particular requirement.

Optionally, the farrier or veterinarian can select the size of shoe 1 best suited to a particular foot.

Shoe 1 also can be fitted before or after being assembled with one or more of such elements 20.

If, on the contrary, shoe 1 is pre-formed and pre-assembled, it will be fitted on the horse foot possibly by selecting the desired size, without the need to perform the above assembly.

Moreover, it is possible to envisage, for the purposes of a further customization of the shoe, that the at least one element 20 can be assembled to a pre-formed and pre-assembled shoe in order to meet specific temporary needs or which occur subsequently for the walk or foot care.

Shoe 1, as said, allows protecting the unshoed horse foot from the onset of pain due to excessive and prolonged exposure to harsh and rocky soils, or also as an adjuvant in the period of convalescence after diseases such as laminitis, the lameness etc., and at the same time, it allows the animal to retain the proper sensitivity during the resting on the ground, allowing in the practice a natural and physiological walking of the so-called “barefoot” type, which in recent years has found increasing acceptance in the horse field.

Boot 1 is also suitable for unshoed horses, for example, in need of a transition period after the removal of the horseshoes to allow the physiological re-adaptation of the foot and the thickening of the horny portions of the same.

The invention thus conceived allows obtaining important technical advantages.

An important technical advantage is the fact that horse shoe 1 can be fitted, by the operator, on the animal's foot with few and simple steps, without the use of locking means of the known type or any kind of tools. The absence of known locking means leads to an obvious gain in terms of time and costs of production of shoe 1, which is made with a smaller number of processing steps.

Alternatively, shoe 1 may have, in a lateral position of the main body 10, at least one hole 8 inside which is inserted at least a lace 9 or at least one band, an elongated element, a band element, completely removable and easily transportable, able to help enlarge the fitting portion 3, and consequently fitting shoe 1.

In an exemplary but non limiting embodiment, such at least one lace 9 is inserted from the outside of shoe 1 through a first hole 8 formed in a lateral portion of the shoe itself, such a lace 9 continues along the inner part of the shoe itself and comes out through a further hole 8. The at least one hole 8 may be positioned in the lateral portion of shoe 1, towards the front, middle or rear part of the same, depending on the needs.

The at least one lace 9 may be inserted and/or fixed to shoe 1 in different ways, without departing from the scope of protection of the present invention.

As seen, horse shoe 1 also allows the optimal adaptation and clamping to feet of any shape, ensuring excellent protection. In fact, following the removal of the horseshoes, the horse foot undergoes changes in shape and diameter. Footwear 1, thanks to the elasticity of the main body 10, adapts in a flexible manner both to the horse foot just unshoed and to the final size that the foot takes after the period of adaptation to the unshoed condition. In this way, shoe 1 adapts to multiple and variable sizes of the horse foot. Such a feature is an advantage compared to the boots on the market which, not being able to adapt to changes in the horse foot, must be replaced at each change.

Moreover, as mentioned, shoe 1 allows the suitable sensitivity to the animal in the resting on the ground, ensuring a natural walking.

Moreover, shoe 1 described herein is particularly suitable to be carried in the walk because it is lightweight, has minimal bulk and, therefore, can be fitted only in the stretches of the walk where there is a rocky or hard ground, and then removed in the other stretches, leaving the horse foot free.

It has thus been seen that the invention achieves the intended objects.

The present invention has been described according to preferred embodiments but equivalent versions may be conceived without departing from the scope of protection offered by the following claims.

1. A horse shoe comprising a main body which reproduces the natural shape of the horse foot, said main body comprising a fitting portion and a sole portion, wherein said sole portion and said fitting portion are made of elastic and/or extensible material and in that said fitting portion can be associated, in use, to at least the hoof of the animal via an elastically deformable coupling, so as to ensure the easy insertion and adaptation of said shoe on the horse foot and allow the optimal protection of the foot both under normal conditions and during a period of convalescence or treatment of the horse and the horse¹s natural gait under normal conditions.

2. The horse shoe according to claim 1, wherein said main body has a frusto-conical shape.

3. The horse shoe according to claim 1, wherein said sole portion comprises at least one tread which follows at least on the lower part the shape of the hoof.

4. The horse shoe according to claim 3, wherein said tread is open at the back or wherein said tread extends at the sole portion of the shoe.

5. The horse shoe according to claim 1, wherein said sole portion comprises at least a central portion adapted to facilitate the fitting and to allow the natural movement of widening and narrowing, or elaterium, of the frog during the walk.

6. The horse shoe according to claim 5, wherein said central portion comprises a central area of said sole portion defined within said tread and extends rearwardly at the opening of said tread itself.

7. The horse shoe according to claim 5, wherein said central portion is elastic, made of the same material as the main body or of a different material from that of the main body or of a compound different from that of the main body or elastic fabric, or of an anti-perforation fabric, etc.

8. The horse shoe according to claim 3, wherein said tread comprises an edge which extends on said fitting portion laterally along the hoof and on the tip of the hoof itself.

9. The horse shoe according claim 3, wherein said tread comprises an engraving suitable for the grip on the ground.

10. The horse shoe according to claim 1, wherein said fitting portion defines a zone of adhesion or coupling at least with the wall of the hoof and with the bulbs of the animal's foot.

11. The horse shoe according to claim 1, made in a single body.

12. The horse shoe according to claim 1, made with a plurality of pieces assembled with each other.

13. The horse shoe according to claim 1, made of a material such as rubber, or vulcanized rubber such as: butadiene-based rubber (polybutadiene or BR), isoprene-based synthetic or natural rubber (IR, NR), IIR or Isobutylene Isoprene Butyl, styrene-butadiene-based rubber (SBR), nitrile rubber, nitrile-butadiene-based rubber (NBR), chloroprene-based rubber (CR), chlorosulfonated polyethylene-based rubber (CSM), bromo butyl isoprene-based rubber (BIIR), chloro butyl isoprene-based rubber (CIIR) thermoplastic rubber of the type TPR, TR, silicone, resin, thermoplastic material, polyurethane (PU), thermoplastic polyurethane (TPU), polyester-based thermoplastic polyurethane (TPU), polyether-based thermoplastic polyurethane (TPU), urethane derivatives, elastic material such as ethylene vinyl acetate (EVA), fabric, non-woven fabric, mixtures of the same, rubber-like materials, etc.

14. The horse shoe according to claim 1, comprising parts with differentiated elasticity obtained through the use of material having different compounds.

15. The horse shoe according to claim 1, comprising parts with differentiated elasticity obtained through the use of material of variable thickness.

16. The horse shoe according to claim 1, obtained in a single molding step, or by co-molding, or by gluing, or by vulcanization, or by assembly or by similar technologies, or by combining several technologies together.

17. The horse shoe according to claim 1, wherein said main body comprises at least one lateral hole adapted to facilitate, through the temporary insertion of at least one removable lace, a band, an elongated element, a band element, or the like, insertable in said at least one hole, the extension and the fit of the shoe on the horse foot.

18. The horse shoe according to claim 1, comprising:
one or more elements comprising at least one insert or a shim or a tread or a cover for the Coronet band or the wall or the tip of the foot or another component, and
coupling means adapted to fasten said at least one element to the main body and/or to its sole portion.

19. The horse shoe according to claim 18, wherein said at least one element has variables or variably selectable thickness, shape and/or hardness so as to be able to customize said shoe.

20. The horse shoe according to claim 18, wherein said coupling means comprise: a glue, Velcro, joint locking means, removable fastening means, adhesive means, magnetized means, etc.

21. The horse shoe according to claim 18, wherein said at least one element can be cut-out from an element that is larger than the element to be applied.

22. Use of the horse shoe according to claim 1 for protecting a bare or unshod horse foot, adapted to facilitate walking, care and/or convalescence of a horse.
